(19) United States
(12) Patent Application Publication
(10) Pub. No.: US 2026/0034737 A1
(43) Pub. Date: Feb. 5, 2026

(54) AI-DRIVEN MICROSTRUCTURE CONTROL FOR RESPONSIVE ADDITIVE MANUFACTURING OPTIMIZATION

(71) Applicant: OptiFab Technologies, Kitchener (CA)

(72) Inventors: Esmaeil SADEGHI, Kitchener (CA); Paria KARIMI, Kitchener (CA)

(21) Appl. No.: 18/789,769

(22) Filed: Jul. 31, 2024

(51) Int. Cl. B29C 64/393; B29C 64/118; B29C 64/135; B29C 64/268; B33Y 10/00; B33Y 30/00; B33Y 50/02

(52) U.S. Cl. CPC B29C 64/393; B29C 64/118; B29C 64/135; B29C 64/268; B33Y 10/00; B33Y 30/00; B33Y 50/02

(57) ABSTRACT

The present disclosure provides an additive manufacturing system. The system comprises a foundation platform supports an object to be manufactured and a material application unit deposits a material onto the foundation platform to manufacture the object. The material application unit comprises a deposition head to deposit the material and a feeder to feed the material to the deposition head. The system further comprises a thermal unit that selectively melts the deposited material, a dynamic positioning unit that facilitates movement of the foundation platform, the material application unit and/or the thermal unit, a sensing unit that determines current operating parameters of each of the material application unit, the thermal unit and the dynamic positioning unit, and a current temperature profile of the melted material and a control unit that determines and optimizes manufacturing parameters for the object based on the current operating parameters and the current temperature profile.

### TECHNICAL FIELD

The present disclosure generally relates to manufacturing systems. Further, the present disclosure particularly relates to additive manufacturing systems, methods for additive manufacturing of objects and computer program products for performing additive manufacturing of objects.

### BACKGROUND

Additive manufacturing has become an essential technology in modern manufacturing processes. The ability to create complex geometries and customized parts with high precision has made additive manufacturing a preferred choice in various industries. The additive manufacturing process generally involves depositing material in a layer-by-layer manner to build objects, contrasting with traditional subtractive manufacturing methods that remove material from a solid block.

Various systems and techniques are known in the field of additive manufacturing. For example, one conventional additive manufacturing system comprises a fused deposition modeling (FDM) setup, which uses a continuous filament of thermoplastic material to build objects layer by layer. A directed energy deposition (DED) based technique involve use of a focused thermal energy source to melt material to create solid structures. A powder bed fusion (PBF) based additive manufacturing device employs a laser or electron beam to selectively fuse powdered material within a bed to form detailed components. Additionally, stereolithography (SLA) employs a vat of liquid photopolymer resin cured by a UV laser to form detailed components. Lastly, binder jetting sprays a liquid binding agent onto a bed of powder, bonding the material to form parts layer by layer. However, these systems often face problems such as inaccurate monitoring and delays in feedback because the rapid pace of the 3D printing process makes it challenging to process data quickly enough to provide near real-time or real-time feedback and adjustments, which hinder near real-time or real-time control and optimization of the manufacturing process. Such a limitation results in suboptimal manufacturing conditions, affecting the quality and consistency of the produced objects.

Another challenge associated with conventional additive manufacturing is the limited integration of intelligent systems to optimize the manufacturing process. While some systems employ basic feedback mechanisms, said are often insufficient to address the complex interactions between different manufacturing parameters. The absence of improved artificial intelligence modules to process data from sensing units and adjust printing parameters accordingly results in a lack of accuracy and efficiency in the manufacturing process.

In addition to said challenges, there is a need for a system which can handle a variety of materials and adapt the printing parameters to suit the specific properties of each material. Conventional systems may not offer the flexibility required to optimize the printing process for different materials, limiting applicability and effectiveness of the system.

In light of the above discussion, there exists an urgent need for solutions that overcome the problems associated with conventional systems and/or techniques for additive manufacturing, particularly in terms of real-time monitoring and near-real-time control of manufacturing parameters.

### SUMMARY

In an aspect, the present disclosure provides an additive manufacturing system. The system comprises a foundation platform to support an object to be manufactured and a material application unit to deposit material in a layer-by-layer manner onto the foundation platform to manufacture the object. The material application unit comprises a deposition head to deposit the material and a feeder to feed the material to the deposition head. The system further comprises a thermal unit to selectively melt the deposited material and a dynamic positioning unit to facilitate movement of at least one of the foundation platform, the material application unit and the thermal unit. The system also a sensing unit to determine current operating parameters of each of the material application unit, the thermal unit and the dynamic positioning unit as well as to determine a current temperature profile of the melted material. Moreover, the system comprises a control unit to determine and optimize manufacturing parameters for the object based on the current operating parameters and the current temperature profile. The manufacturing parameters comprise the quantity of material deposited, heating settings, cooling speed, speed of the dynamic positioning unit and direction of the dynamic positioning unit.

Such an additive manufacturing system enables precise control over the manufacturing process, resulting in improved accuracy and quality of the manufactured object. Furthermore, the integration of the control unit with the sensing unit facilitates real-time optimization of manufacturing parameters, thereby enhancing efficiency.

In an embodiment, the additive manufacturing system comprises a heating element integrated within the foundation platform. The inclusion of the heating element in the foundation platform enables uniform heating of the object during manufacturing, reducing thermal stresses and potential deformation.

In an embodiment, the material application unit comprises a material reservoir connected to the feeder and the feeder transports the material from the material reservoir to the deposition head in a controlled manner. The controlled transportation of material ensures consistent material flow, improving the uniformity and strength of the manufactured object.

In an embodiment, the thermal unit comprises a laser source and a set of focusing lenses. The laser source emits a laser beam that is directed and focused by the set of focusing lenses onto the deposited material to selectively melt and fuse the material. The use of the laser source and focusing lenses enables precise control over the melting process, resulting in high-resolution and complex geometries in the manufactured object.

In an embodiment, the dynamic positioning unit comprises a plurality of linear actuators and rotary motors. The plurality of linear actuators and rotary motors provides multi-axis movement for the foundation platform, the material application unit and the thermal unit. Such a dynamic positioning unit enables accurate and flexible positioning of the components, enhancing the precision and versatility of the manufacturing process.

In an embodiment, the dynamic positioning unit comprises ball screws and servo motors for linear actuators, stepper motors for rotary motors and precision guides and bearings comprising linear rails and recirculating ball bearings. The integration of such components in the dynamic positioning unit enables high precision and smooth operation, contributing to the overall accuracy and quality of the manufactured object.

In an embodiment, the dynamic positioning unit comprises precision guides and bearings. Such precision guides and bearings ensure smooth and accurate movement of the components, further enhancing the precision of the manufacturing process.

In an embodiment, the sensing unit comprises a plurality of sensors selected from an infrared camera, a laser profilometer, a thermal imaging camera, a photodiode and a pyrometer. The inclusion of various sensors in the sensing unit enables comprehensive monitoring of the manufacturing process, providing critical data for optimizing manufacturing parameters.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 shows a perspective view of an additive manufacturing system, in accordance with an embodiment of the present disclosure;

FIG. 2 shows a block diagram of the additive manufacturing system of FIG. 1, in accordance with an embodiment of the present disclosure;

FIG. 3 shows a flowchart of a method for additive manufacturing of an object, in accordance with an embodiment of the present disclosure; and

FIG. 4 shows a sequence diagram of the method of FIG. 3, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

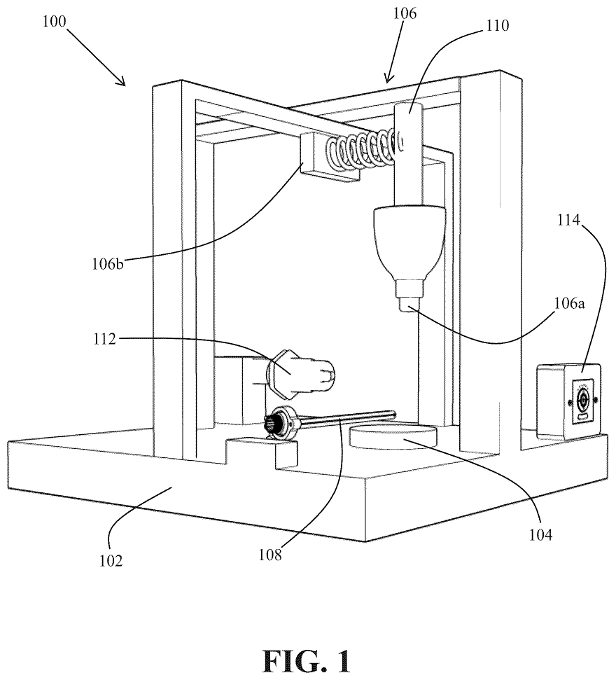

Referring to FIG. 1, there is shown a perspective view of an additive manufacturing system 100, in accordance with an embodiment of the present disclosure.

The term “additive manufacturing system” as used throughout the present disclosure relates to an apparatus for creating three-dimensional objects through an additive manufacturing process. The system comprises several interconnected components working together to build objects layer by layer. The system enables the deposition of material to form the manufactured object.

The term “foundation platform” as used throughout the present disclosure relates to the surface within the additive manufacturing system that supports the object to be manufactured. The foundation platform ensures stability and accuracy during the material deposition process, providing a base for the layer-by-layer construction of the object.

The term “object” as used throughout the present disclosure relates to the three-dimensional structure being created by the additive manufacturing system. The object is built up layer by layer on the foundation platform through the controlled deposition of material.

The term “material application unit” as used throughout the present disclosure relates to the component responsible for depositing material onto the foundation platform in a layer-by-layer manner to form the object. The material application unit comprises the deposition head and the feeder.

The term “deposition head” as used throughout the present disclosure relates to the part of the material application unit that directly deposits the material onto the foundation platform. The deposition head ensures precise placement of the material during the construction of the object.

The term “feeder” as used throughout the present disclosure relates to the mechanism within the material application unit that transports material from a reservoir to the deposition head. The feeder regulates the flow of material to ensure consistent and controlled deposition.

The term “thermal unit” as used throughout the present disclosure relates to the component that selectively melts the deposited material. The thermal unit provides the necessary thermal energy to fuse the material layers, ensuring proper adhesion and structural integrity of the object. The thermal unit comprises a heating source, such as a laser, resistance heater, microwave etc., which serves as the primary means of supplying heat. Additionally, the thermal unit includes a guide mechanism that enables the precise and selective heating of the material, ensuring that only the desired areas are melted. Furthermore, a regulation unit is incorporated to control the amount of energy supplied to the heating source, thereby allowing for precise thermal management during the manufacturing process. The thermal unit can vary heating to enable those different materials (e.g., plastic/polymer, ceramic, metal etc.) and layer thicknesses can be appropriately handled. The heating variability enable to achieve optimal melting and fusion conditions, which in turn enhances the mechanical properties and overall quality of the manufactured object. Variable heating also allows for the accommodation of complex geometries and varying material properties within a single build, thus expanding the capabilities and applications of additive manufacturing process. The heating source can adjust temperature settings based on the material type and the specific requirements of the manufacturing task.

The term “dynamic positioning unit” as used throughout the present disclosure relates to the system that facilitates movement of the foundation platform, the material application unit and the thermal unit. The dynamic positioning unit allows for precise multi-axis positioning, enabling accurate layer-by-layer construction of the object.

The term “sensing unit” as used throughout the present disclosure relates to the component that determines the current operating parameters of the material application unit, the thermal unit and the dynamic positioning unit, as well as the current temperature profile of the melted material. The sensing unit provides real-time data for optimizing the manufacturing process. The sensing unit comprises various sensors selected from an infrared camera, a laser profilometer, a thermal imaging camera, a photodiode, and a pyrometer. The sensing unit collects data on the manufacturing process environment and the object being printed, for example temperature, layer thickness, and material deposition accuracy. The sensing unit provides continuous feedback to the control unit and the AI module, enabling dynamic adjustments to optimize the printing process.

The term “control unit” as used throughout the present disclosure relates to the component that determines and optimizes manufacturing parameters based on data from the sensing unit. The control unit coordinates the actions of the material application unit, the thermal unit and the dynamic positioning unit to enhance the quality and integrity of the manufactured object.

The term “real-time” as used throughout the present disclosure relates to the immediate processing and response to data as is collected during any operational process. Such processing enable that adjustments are made without perceptible delay, maintaining optimal conditions for the given process. It would be apricated that there exists a time difference between sensing, analysis, and the execution of actions based on the analysis. Such a time difference can range from microseconds to nanoseconds. For example, in an additive manufacturing process, there may be a delay of 10-100 microseconds between the detection of temperature by the sensing unit and the control of the heating source. Such a delay includes the time taken for the sensing unit to transmit data to the control unit and AI module, for the AI module to analyse the data, and for the control unit to execute the necessary adjustments.

The system 100 comprises the foundation platform 102 that supports the object 104 to be manufactured. The foundation platform 102 provides a stable surface for the layer-by-layer deposition of material, which is important for achieving high dimensional accuracy and surface finish of the manufactured object 104. The rigidity of the foundation platform 102 minimizes vibrations and movement during the manufacturing process, contributing to the consistency and reliability of the final product. The foundation platform 102 can be adjusted to accommodate different object sizes and shapes, providing a versatile base for various manufacturing tasks. The foundation platform 102 interacts with the material application unit 106, which deposits the material onto the platform as well as with the thermal unit 108, which enables the material to be properly melted and fused. The build platform 102 is constructed from a durable material capable of withstanding high temperatures and mechanical stresses encountered during the 3D printing process. The surface of the build platform (102) provides required adhesion to the deposited material while also allowing easy removal of the finished printed object. Build platform 102 maintains a stable and level position, enabling the accuracy and precision of the printed layers. The build platform 102 can be heated to optimize the material bonding process, which reduces warping and improves the structural integrity of the printed object.

The system 100 comprises the material application unit 106 that deposits a material, in a layer-by-layer manner, onto the foundation platform 102 to manufacture the object 104. The material application unit 106 comprises a deposition head 106a to deposit the material and a feeder 106b to feed the material to the deposition head 106a. The material application unit 106 comprises mechanisms for controlling the flow and placement of the material, which can comprise various forms, such as filaments, powders or liquids depending on the type of additive manufacturing technique employed.

The material application unit 106 enables uniform distribution of material across each layer, which is important for maintaining the dimensional accuracy and surface finish of the manufactured object 104. Further, during operation, the material application unit 106 operates in synchronization with the dynamic positioning unit 110 to follow the specified manufacturing path accurately. The material application unit 106 also plays a role in controlling the deposition speed, which affects the resolution and overall quality of the manufactured object 104.

The system 100 comprises the thermal unit 108 that selectively melts or soften the deposited material. The thermal unit 108 provides the necessary thermal energy to melt the material prior to deposition, enabling proper fusion between layers and eliminating voids or weak spots in the manufactured object 104. The thermal unit 108 is controlled to maintain optimal temperature settings which correspond to the melting point of the material. The thermal unit 108 contributes to a smoother surface finish and reduces the occurrence of defects such as voids or weak spots in the manufactured object 104. The thermal unit 108 can utilize various heating techniques, for example resistive heating elements, lasers, or induction heaters, depending on the material being used. The thermal unit 108 is controlled to maintain optimal temperature settings which correspond to the material's melting point.

The system 100 comprises the dynamic positioning unit 110 that facilitates movement of at least one of the foundation platform 102, the material application unit 106 and the thermal unit 108. The dynamic positioning unit 110 comprises motors, actuators and precision guides which coordinate the movements required to follow the predetermined manufacturing path. The dynamic positioning unit 110 operates with high accuracy and repeatability, which is important for producing complex geometries and intricate details in the manufactured object 104. The dynamic positioning unit 110 can adjust the speed and direction of movement to optimize the deposition process, enabling each layer to be accurately positioned. The ability of the dynamic positioning unit 110 to adapt to different manufacturing speeds and directions improves the flexibility and capability of the additive manufacturing system 100 to produce a wide range of objects with varying complexities. For example, the dynamic positioning unit 110 may control the movement of the foundation platform 102 to enable layering of materials. Additionally, dynamic positioning unit 110 may adjust the position of the material application unit 106 to apply material to specific areas as needed. Similarly, the dynamic positioning unit 110 can maneuver the thermal unit 108 to selectively apply heat, ensuring proper fusion of the material layers. Dynamic control improves precision and flexibility in the manufacturing process, allowing for the creation of complex and detailed object.

The system 100 comprises the sensing unit 112 that determines current operating parameters of each of the material application unit 106, the thermal unit 108 and the dynamic positioning unit 110 and a current temperature profile of the melted material. The sensing unit 112 comprises various sensors selected from an infrared camera, a laser profilometer, a thermal imaging camera, a photodiode and a pyrometer. The sensing unit 112 collects data (in near real-time, such as 1-10 nanoseconds, 5-500 microseconds, 2 seconds and the like) on the manufacturing environment and the object 104 being manufactured, such as temperature, layer thickness and material deposition accuracy. The sensing unit 112 provides continuous feedback to the control unit 114, enabling dynamic adjustments to optimize the manufacturing process. The inclusion of such sensors allows for monitoring of various parameters, which is important for maintaining manufacturing quality. The near real-time feedback loop improves the reliability and repeatability of the additive manufacturing system 100.

The system 100 comprises the control unit 114 that determines and optimizes manufacturing parameters for the object 104 based on the current operating parameters and the current temperature profile. The manufacturing parameters comprise the quantity of the material deposited, heating settings, cooling speed, speed of the dynamic positioning unit 110 and direction of the dynamic positioning unit 110. The control unit 114 coordinates the actions of the material application unit 106, the thermal unit 108 and the dynamic positioning unit 110 to optimize the manufacturing process. The control unit 114 continuously monitors the manufacturing environment and makes real-time or near real-time dynamic adjustments to enable the desired outcome.

The control unit 114 acts as the central processing hub, leading to a seamless and efficient operation of the additive manufacturing system 100. The ability of the control unit 114 to manage and adjust various manufacturing parameters enables the creation of high-quality objects with desired properties.

The control unit 114 receives real-time data from the sensing unit 112 and utilizes the AI module to make necessary adjustments to the printing parameters to achieve higher precision and quality of the object to be manufactured. For example, if the sensing unit 112 detects a deviation in the melting temperature of the printing material, the control unit 114 utilize AI module to determine dynamic adjustment in at least one of printing speed, thermal setting of heating source or material flow rate to compensate for the deviation.

The AI module of control unit 114 utilizes historical data (collected from previous additive manufacturing processes) to generate one or more Artificial Intelligence (AI) models. The historical data comprises information about successful and unsuccessful print jobs, variations in printing conditions, and the corresponding adjustments made. By analysing such historical data, the AI module learns patterns and develops models that predict the optimal settings for different scenarios. The control unit 114 correlates current data with historical data to modify various parameters of additive manufacturing.

The AI model uses machine learning algorithms to identify correlations between different parameters and their impact on the final product quality. For instance, if historical data shows that a specific material flow rate and temperature combination yields the best results for a particular design, the AI model can recommend such settings when similar conditions are detected. The control unit 114 applies such recommendations to adjust the printing parameters to enhance efficiency and quality of the manufacturing process. In an example scenario, the sensing unit 112 detects that the layer thickness is deviating from the desired specification. The control unit 114 references the AI model, which indicates that reducing the material flow rate has corrected similar issues in the past. The control unit 114 then adjusts the material flow rate, accordingly, bringing the layer thickness back within acceptable limits. Such dynamic correlation of current data with historical data enables continuous improvement and optimization of the additive manufacturing process.

The term AI module employs machine learning algorithms to analyze real-time data and historical patterns to make dynamic adjustments to parameters such as temperature, material flow rate, and printing speed, thereby ensuring optimal solidification of the printed layers. The optimization of solidification is critical for controlling the microstructure of the manufactured object. The term “solidification” as used throughout the present disclosure relates to the process of a liquid material or melted material becoming solid upon cooling. The term “microstructure” as used throughout the present disclosure relates to the small-scale structure of a material, as observed through a microscope, which influences the material's mechanical properties and overall performance. By controlling solidification, the AI module can directly affect the microstructure, ensuring the final product meets the desired specifications. The AI module optimizes solidification is through near real-time monitoring and adjustment of temperature. The AI module continuously receives data from the sensing unit 112, which monitors the temperature of the material being printed. If the AI module detects that the material is cooling too quickly, which might lead to unwanted microstructures such as excessive grain growth, AI module dynamically adjusts the printing speed or the heat source to maintain an optimal cooling rate. Conversely, if the material is cooling too slowly, the AI module increases the cooling rate to prevent defects like porosity. In another embodiment, the control unit 114 adjusts the material flow rate in response to detection of uneven solidification and microstructure inconsistencies. By ensuring a stable and controlled material flow rate, the AI module of control unit 114 helps achieve uniform solidification, thereby producing a consistent microstructure across the entire object. Through AI module control unit 114 optimizes solidification by controlling the layer thickness. Thicker layers may cool and solidify differently compared to thinner layers, affecting the microstructure. The AI module dynamically adjusts the layer thickness based on real-time data and historical insights to ensure each layer solidifies in a manner that promotes the desired microstructural properties.

In an embodiment, the AI module utilizes historical data to predict and mitigate potential solidification issues. By analyzing previous print jobs, the AI module identifies patterns and correlations between various parameters and solidification outcomes. For instance, AI model may learn that certain combinations of temperature and material flow rate consistently result in optimal microstructure for specific materials. Such predictive capabilities enable the AI module to dynamically adjust parameters before issues arise, enabling continuous improvement in the manufacturing process.

In another embodiment, solidification can be controlled to optimize microstructure by dynamic controlled cooling and reheating cycles. The AI module can introduce controlled pauses in the printing process, allowing for partial cooling and subsequent reheating. Such a technique can refine the microstructure by promoting desirable grain structures and eliminating defects. Additionally, the AI module can implement in-situ annealing during the printing process. The term “annealing” as used throughout the present disclosure relates to a heat treatment process that alters the microstructure of a material to increase its ductility and reduce hardness. By integrating short annealing cycles during printing, the AI module can enhance the mechanical properties of the final product.

In another embodiment, the control unit 114 can control cooling mechanism for optimizing solidification. The control unit 114 can activate a fan to direct airflow over the printed material, thereby controlling the cooling rate. Adjusting the airflow direction and speed enable even cooling to achieve uniform microstructure. Optionally, the control unit 114 can vary humidity levels around the printing area to maintain optimal conditions for solidification.

Furthermore, the control unit can enable spraying of coolant onto the printed layers to dynamically control solidification. The control unit 114 can determine the appropriate timing and quantity of coolant spray to enhance the solidification process without causing thermal shock to prevent defects and ensures the desired microstructural properties. As control unit 114 dynamically adjusts additive manufacturing process, uncontrolled solidification in additive manufacturing can be prevented. The uncontrolled solidification can lead to various microstructural defects, including excessive grain growth, porosity, and uneven layer deposition. Excessive grain growth occurs when the material cools too slowly, resulting in larger grains that weaken the mechanical properties of the material. Such grains can cause brittleness and reduce the overall strength of the manufactured object.

The control unit 114 adjust solidification based on data from sensing unit 112, porosity (i.e., presence of voids or pores within the material occurs when the material cools too quickly or unevenly) can be prevented. The porosity compromises the structural integrity and durability of the product, or even crack/fracture formation in object. The dynamic control of solidification (through control unit 114) enables the regulation of manufacturing parameters to overcome the impacts of aforesaid uncontrolled solidification on microstructure. The dynamic cooling enables prevention of excessive grain growth by maintaining a consistent cooling rate, minimizes porosity by enabling even cooling and proper material deposition. Furthermore, dynamic sonification control facilitates uniform layer deposition, resulting in a consistent and defect-free microstructure to improve mechanical properties, durability, and overall performance of the final product, to meet required specifications and performs reliability.

Such a system 100 enables the deposition of material to form a 3D printed object 104. The interaction between the components, for example the coordination between the material application unit 106 and the thermal unit 108, enables accurate control over the manufacturing process, leading to reduced defects and improved part integrity. The foundation platform 102 provides a stable base for the manufacturing process; the material application unit 106 ensures precise deposition; the thermal unit 108 allows proper material fusion; the dynamic positioning unit 110 enables accurate movement; the sensing unit 112 monitors critical parameters; and the control unit 114 optimizes the entire process for high-quality output.

In an embodiment, the foundation platform 102 comprises a heating element integrated within the platform. The heating element provides controlled heating to the foundation platform 102, which helps in maintaining the optimal temperature for the material deposition process. Such controlled heating reduces the risk of warping and enhances the adhesion of the material layers, leading to improved structural integrity and dimensional accuracy of the manufactured object 104. The heating element within the foundation platform 102 enables uniform heat distribution, which is important for achieving consistent manufacturing results. The integration of the heating element allows for the precise control of the platform temperature, improving adhesion and reducing material defects.

In an embodiment, the material application unit 106 comprises a material reservoir connected to the feeder 106b. The feeder 106b transports the material from the material reservoir to the deposition head 106a in a controlled manner. The material reservoir stores the material to be deposited, enabling continuous supply during the manufacturing process. The feeder 106b regulates the flow of material, providing precise control over the amount of material delivered to the deposition head 106a. Such controlled feeding enables accurate material deposition, which is important for maintaining the quality and consistency of the manufactured object 104. The integration of the material reservoir with the feeder 106b enhances the efficiency of the material application unit 106, allowing for uninterrupted manufacturing operations. This consistent material flow minimizes defects such as under-extrusion or over-extrusion, thus improving the dimensional accuracy and surface finish of the printed parts.

In an embodiment, the thermal unit 108 comprises a laser source and a set of focusing lenses. The laser source emits a laser beam that is directed and focused by the set of focusing lenses onto the deposited material to selectively melt and fuse the material. The laser source provides high-intensity thermal energy, enabling precise melting of the material. The set of focusing lenses directs the laser beam accurately, ensuring targeted heating and fusion of the material layers. Such selective melting and fusing enhance the bonding strength between layers, improving the overall structural integrity of the manufactured object 104. The use of the laser source in the thermal unit 108 allows for high precision and control in the additive manufacturing process. The precision offered by the laser and lenses ensures efficient use of thermal energy, leading to reduced material wastage and improved mechanical properties of the finished product.

In an embodiment, the dynamic positioning unit 110 comprises a plurality of linear actuators and rotary motors. The plurality of linear actuators and rotary motors provides multi-axis movement for the foundation platform 102, the material application unit 106 and the thermal unit 108. The linear actuators enable precise linear movements, while the rotary motors allow for rotational movements. Such multi-axis movement capability enhances the flexibility and versatility of the additive manufacturing system 100, allowing the additive manufacturing system 100 to produce complex geometries and intricate details in the manufactured object 104. The ability of the dynamic positioning unit 110 to coordinate movements across multiple axes improves the accuracy and efficiency of the manufacturing process.

In an embodiment, the plurality of linear actuators in the dynamic positioning unit 110 comprises ball screws and servo motors and the plurality of rotary motors comprises stepper motors. The precision guides and bearings comprise linear rails and recirculating ball bearings. The ball screws and servo motors enable precise and smooth linear movements, while the stepper motors provide accurate rotational positioning. The incorporation of ball screws and servo motors within the linear actuators, along with stepper motors in the rotary systems, enhances the accuracy and responsiveness of movements. The precision guides and bearings, including linear rails and recirculating ball bearings, further contribute to the smooth and precise positioning of the various components, reducing vibrations and ensuring stable operation. The linear rails and recirculating ball bearings further ensure stable and precise guidance of the moving components. Such components enhance the overall precision and reliability of the dynamic positioning unit 110, contributing to the high-quality output of the additive manufacturing system 100. The use of advanced components in the dynamic positioning unit 110 ensures consistent and repeatable manufacturing results.

In an embodiment, the dynamic positioning unit 110 comprises precision guides and bearings. The precision guides and bearings facilitate smooth and accurate movement of the foundation platform 102, the material application unit 106 and the thermal unit 108. Such precision components reduce friction and wear, enhancing the durability and reliability of the dynamic positioning unit 110. The use of precision guides and bearings enables high accuracy in the positioning and movement of the system components, which is important for achieving high-quality manufacturing outcomes. The integration of precision guides and bearings in the dynamic positioning unit 110 improves the overall performance and longevity of the additive manufacturing system 100.

In an embodiment, the sensing unit 112 comprises a plurality of sensors selected from an infrared camera, a laser profilometer, a thermal imaging camera, a photodiode and a pyrometer. The plurality of sensors monitors various parameters during the manufacturing process, such as temperature, layer thickness and material flow. The data collected by sensors provide real-time feedback to the control unit 114, enabling dynamic adjustments to optimize the manufacturing process. The use of multiple sensors ensures comprehensive monitoring and control of the manufacturing environment, which is important for maintaining the quality and consistency of the manufactured object 104. The integration of advanced sensing technologies in the sensing unit 112 enhances the overall accuracy and reliability of the additive manufacturing system 100. These sensors enable the detection of temperature variations, surface profiles and material deposition accuracy, allowing for immediate adjustments and ensuring optimal process conditions are maintained.

In an embodiment, the control unit 114 dynamically controls thermal gradients to optimize solidification parameters in the additive manufacturing process. The term “thermal gradient” as used throughout the present disclosure relates to the rate of temperature change over a specific distance within the material being printed. The thermal gradient regulates microstructure of the final product. The control unit dynamically control thermal gradient, which affects the grain size, porosity, and overall mechanical properties of the printed object. As steep thermal gradient can lead to rapid cooling, resulting in smaller grain sizes and potentially higher strength but also increased risk of residual stresses and cracks, by controlling thermal gradient during solidification process the control unit 114 prevent aforesaid defects. The control unit 114, in conjunction with the AI module, dynamically adjusts the thermal gradient to maintain optimal solidification conditions. Such dynamic control involves real-time monitoring and modification of parameters such as temperature, material flow rate, and cooling mechanisms to achieve uniform thermal gradient across the material. For example, if the control unit detects a steep thermal gradient, the control unit 114 may adjust the heating source or activate a cooling mechanism to balance the temperature distribution. The AI module analyses real-time data and historical patterns to predict and mitigate potential thermal gradient issues. By maintaining a uniform thermal gradient, the control unit 114 enables that the molten material cools evenly, preventing defects such as uneven grain growth and porosity. Such uniform cooling enhances the mechanical properties and reliability of the final product. Throughout the present disclosure, non-limiting examples of solidification parameters may include cooling rate, temperature gradient, material flow rate, layer thickness, heat source intensity, environmental conditions, and cooling mechanisms. By managing thermal gradients effectively, the control unit (114) reduces the likelihood of warping, shrinkage and cracking, thus preserving the geometric and structural integrity of the printed object.

The control unit 114 continuously monitors the temperature distribution across the build platform 102 or plate or substrate or chamber (in which object is under printing process) or printing head or heat-source and the printed object using data from the sensing unit 112.

In another embodiment, the control unit 114 can develop data-driven energy management strategy by optimizing energy consumption through the integration of data collected from melt pool monitoring devices. Said system 100 utilizes AI module to enhance energy efficiency during the 3D printing process/additive manufacturing process. The data collected from sensing unit 112, including real-time data on temperature and shape, is processed by machine learning models. Such machine learning models predict the optimal energy input required for various printing conditions. By analyzing the real-time data, the system 100 determines the necessary adjustments in laser power and scan patterns to achieve the desired print quality while minimizing energy usage. For instance, if the machine learning model identifies that a lower laser power is adequate for maintaining the desired melt pool characteristics under certain conditions, the control unit 114 dynamically reduces the laser power accordingly. Similarly, adjustments to the scan patterns are made to enable efficient energy usage while retaining the quality of the printed object. This dynamic adjustment process allows for a significant reduction in power consumption, thereby achieving efficient energy management.

In one embodiment, said control unit 114 continuously learns from the data collected during multiple printing sessions. This continuous learning process enables the system 100 to refine its predictions and adjustments, leading to progressively optimized energy usage over time. The integration of real-time data analysis with machine learning ensures that the system 100 adapts to varying printing conditions and maintains energy efficiency. The implementation of data-driven energy management within the system 100 results in lower electricity costs, contributing to the economic efficiency of the manufacturing process. Furthermore, by reducing energy consumption, the system 100 lowers the environmental footprint of the 3D printing process. This reduction in energy usage aligns with sustainable manufacturing practices, promoting an eco-friendly approach to 3D printing.

The control unit 114 dynamically adjusts said components to achieve desired mechanical, thermal, and electrical properties in the printed object. By regulating the material deposition, the control unit 114 enables uniform layer formation, which is important for the structural integrity of the object. The heating source is controlled to maintain optimal melting and solidification conditions, preventing defects for example warping and cracking.

In an embodiment, the AI module or control unit 114 may further provide automated post-processing recommendations based on the required morphological properties. The control unit 114 analyses the aspects of the printed object and suggests post-processing steps to achieve the desired surface finish, dimensional accuracy, and other morphological characteristics.

Recommendations may comprise annealing, polishing, or coating processes tailored to improve specific properties of the printed object.

In an embodiment, the control unit 114 may adjust the required energy supplied to a laser and a heating element of a nozzle or a liquefier head to extrude a molten material. The control unit 114 dynamically regulates the power levels based on the material type and specific printing requirements. By controlling the energy input, the system 100 enables the material which reaches the correct melting point, allowing for smooth extrusion and proper layer bonding. The laser provides focused thermal energy for high-precision melting, while the heating element maintains consistent temperature conditions within the liquefier head. Said control over energy input reduces energy consumption and prevents overheating, which can cause material degradation or structural defects.

Through the utilization of predictive analytics, the system provides recommendations for corrective actions during manufacturing. Such recommendations may include adjustments to laser power, modifications to scan patterns, or alterations to build environment parameters. By implementing these suggestions, the likelihood of defects is significantly reduced, thereby improving the reliability of additive manufacturing.

In one embodiment, said predictive analytics continuously monitors the real-time data collected sensing unit 112 and compares it with historical data to detect anomalies. When a pattern suggestive of a potential failure is identified, the control unit 114 promptly provides corrective action recommendations to the operator. For instance, if incomplete fusion is detected, the control unit 114 may increase in laser power or a change in scan pattern to ensure complete melting of the material.

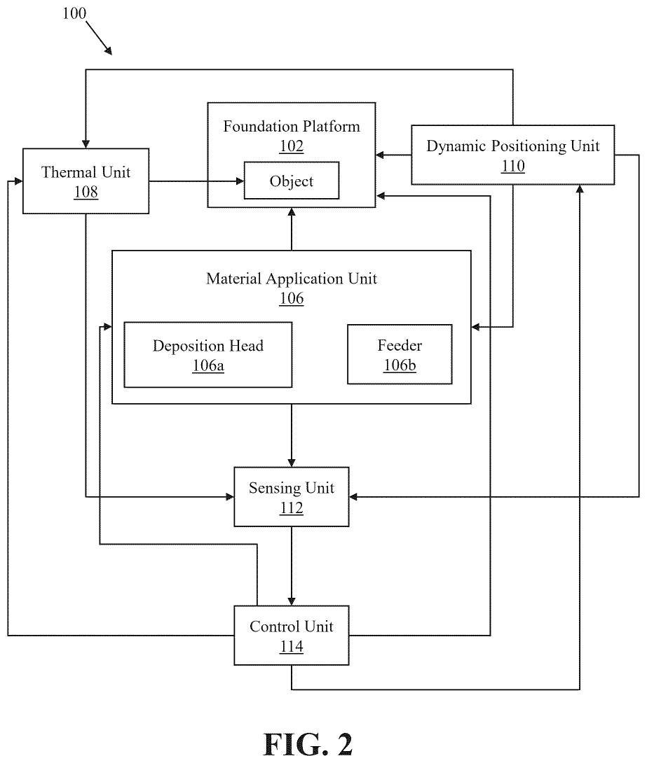

Referring to FIG. 2, there is shown a block diagram of the additive manufacturing system 100 of FIG. 1, in accordance with an embodiment of the present disclosure. The additive manufacturing system 100 comprises the foundation platform 102 that supports an object 104 to be manufactured; the material application unit 106 that deposits material onto the foundation platform 102 in a layer-by-layer manner; the thermal unit 108 that selectively melts the deposited material; the dynamic positioning unit 110 that facilitates movement of the foundation platform 102, the material application unit 106, and the thermal unit 108; the sensing unit 112 that determines current operating parameters and temperature profiles; and the control unit 114 that determines and optimizes manufacturing parameters. The foundation platform 102 ensures stability and accuracy during deposition, the material application unit 106 provides precise material layering, the thermal unit 108 enables proper fusion of material layers, the dynamic positioning unit 110 allows for multi-axis movement and precise placement, the sensing unit 112 offers real-time monitoring and feedback and the control unit 114 optimizes the entire process to enhance the quality and integrity of the manufactured object.

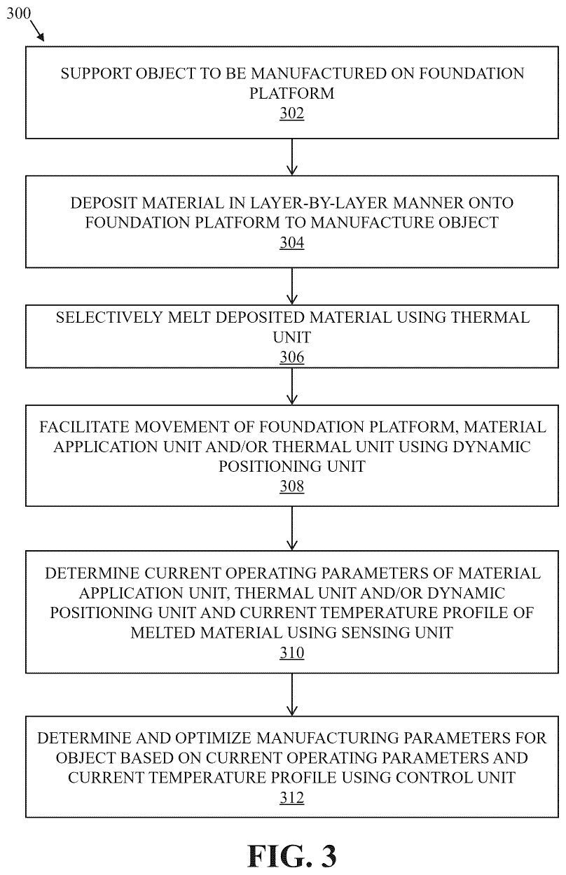

Referring to FIG. 3, there is shown a flowchart 300 of a method for additive manufacturing of an object, in accordance with an embodiment of the present disclosure. At a step 302, the object to be manufactured is supported on a foundation platform. At a step 304, a material is deposited, in a layer-by-layer manner, onto the foundation platform to manufacture the object. The material application unit comprises a deposition head to deposit the material and a feeder to feed the material to the deposition head. At a step 306, the deposited material is selectively melted using a thermal unit. At a step 308, movement of at least one of the foundation platform, the material application unit and the thermal unit is facilitated using a dynamic positioning unit. At a step 310, current operating parameters of each of the material application unit, the thermal unit and the dynamic positioning unit and a current temperature profile of the melted material are determined using a sensing unit. At a step 312, manufacturing parameters for the object are determined and optimized based on the current operating parameters and the current temperature profile using a control unit. The manufacturing parameters comprise quantity of the material deposited, heating settings, cooling speed, speed of the dynamic positioning unit and direction of the dynamic positioning unit.

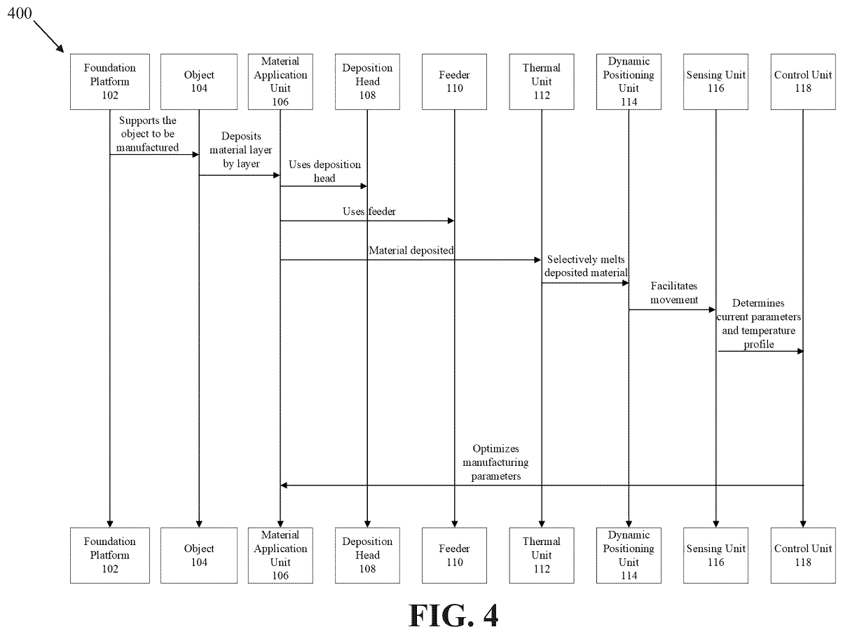

Referring to FIG. 4, there is shown a sequence diagram of the method of FIG. 3, in accordance with an embodiment of the present disclosure. The method for additive manufacturing of an object 104 comprises supporting the object 104 to be manufactured on the foundation platform 102. The method comprises depositing a material in a layer-by-layer manner onto the foundation platform 102 using the material application unit 106, which comprises the deposition head 106a to deposit the material and the feeder 106b to feed the material to the deposition head 106a. As shown, the method further comprises selectively melting the deposited material using the thermal unit 108. As shown, the method further comprises facilitating movement of at least one of the foundation platform 102, the material application unit 106, and the thermal unit 108 using the dynamic positioning unit 110. The method also comprises determining current operating parameters of each of the material application unit 106, the thermal unit 108 and the dynamic positioning unit 110, as well as a current temperature profile of the melted material using the sensing unit 112. Finally, the method comprises determining and optimizing manufacturing parameters for the object 104 based on the current operating parameters and the current temperature profile using the control unit 114. The manufacturing parameters include the quantity of material deposited, heating settings, cooling speed, speed of the dynamic positioning unit 110 and direction of the dynamic positioning unit 110.

In an embodiment, the material application unit comprises a material reservoir connected to the feeder. The method comprises transporting the material from the material reservoir to the deposition head in a controlled manner.

In an embodiment, the thermal unit comprises a laser source and a set of focusing lenses. The method comprises emitting a laser beam by the laser source and directing and focusing the emitted laser beam by the set of focusing lenses onto the deposited material to selectively melt and fuse the material.

Further disclosed is a computer program product comprising a non-transitory computer-readable storage medium storing instructions which, when executed by a processor, cause an additive manufacturing system to perform a method for additive manufacturing of an object. The method comprises supporting the object to be manufactured on a foundation platform and depositing a material in a layer-by-layer manner onto the foundation platform to manufacture the object. The material application unit comprises a deposition head to deposit the material and a feeder to feed the material to the deposition head. The method further comprises selectively melting the deposited material using a thermal unit, facilitating movement of at least one of the foundation platform, the material application unit and the thermal unit using a dynamic positioning unit, determining current operating parameters of each of the material application unit, the thermal unit. and the dynamic positioning unit using a sensing unit, determining a current temperature profile of the melted material using the sensing unit, and determining and optimizing manufacturing parameters for the object based on the current operating parameters and the current temperature profile using a control unit. The manufacturing parameters comprise quantity of the material deposited, heating settings, cooling speed, speed of the dynamic positioning unit and direction of the dynamic positioning unit.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general-purpose computer, special purpose computer, or other programmable data processing apparatus to produce a machine, such that the instructions which execute on the computer or other programmable data processing apparatus create means for implementing the functions specified in the flowchart block or blocks.

Throughout the present disclosure, the term ‘processing means’ or ‘microprocessor’ or ‘processor’ or ‘processors’ or ‘control unit’ includes, but is not limited to, a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

The term “non-transitory storage device” or “storage” or “memory,” as used herein relates to a random-access memory, read only memory and variants thereof, in which a computer can store data or software for any duration.

Operations in accordance with a variety of aspects of the disclosure is described above would not have to be performed in the precise order described. Rather, various steps can be handled in reverse order or simultaneously or not at all.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Throughout the present disclosure, the term ‘Artificial intelligence (AI)’ as used herein relates to any mechanism or computationally intelligent system that combines knowledge, techniques, and methodologies for controlling a bot or other element within a computing environment. Furthermore, the artificial intelligence (AI) is configured to apply knowledge and that can adapt it-self and learn to do better in changing environments. Additionally, employing any computationally intelligent technique, the artificial intelligence (AI) is operable to adapt to unknown or changing environment for better performance. The artificial intelligence (AI) includes fuzzy logic engines, decision-making engines, preset targeting accuracy levels, and/or programmatically intelligent software.

What is claimed is:

1. An additive manufacturing system, wherein the system comprises:
a foundation platform supports an object to be manufactured;
a material application unit deposits a material, in a layer-by-layer manner, onto the foundation platform to manufacture the object, wherein the material application unit comprises:
a deposition head to deposit the material; and
a feeder to feed the material to the deposition head;
a thermal unit selectively melts the deposited material;
a dynamic positioning unit facilitates movement of at least one of: the foundation platform, the material application unit and the thermal unit;
a sensing unit determines:
current operating parameters of each of the material application unit, the thermal unit and the dynamic positioning unit; and
a current temperature profile of the melted material; and
a control unit determines and optimizes manufacturing parameters for the object based on the current operating parameters and the current temperature profile, wherein the manufacturing parameters comprise:
quantity of the material deposited;
heating settings;
cooling speed;
speed of the dynamic positioning unit; and
direction of the dynamic positioning unit.

2. The additive manufacturing system as claimed in claim 1, wherein the foundation platform comprises a heating element integrated within the platform.

3. The additive manufacturing system as claimed in claim 1, wherein the material application unit comprises a material reservoir connected to the feeder and wherein the feeder transports the material from the material reservoir to the deposition head in a controlled manner.

4. The additive manufacturing system as claimed in claim 1, wherein the thermal unit comprises a laser source and a set of focusing lenses and wherein the laser source emits a laser beam that is directed and focused by the set of focusing lenses onto the deposited material to selectively melt and fuse the material.

5. The additive manufacturing system as claimed in claim 1, wherein the dynamic positioning unit comprises a plurality of linear actuators and rotary motors and wherein the plurality of linear actuators and rotary motors provides multi-axis movement for the foundation platform, the material application unit and the thermal unit.

6. The additive manufacturing system as claimed in claim 5, wherein the plurality of linear actuators comprises ball screws and servo motors and the plurality of rotary motors comprise stepper motors and wherein the precision guides and bearings comprise linear rails and recirculating ball bearings.

7. The additive manufacturing system as claimed in claim 1, wherein the dynamic positioning unit comprises precision guides and bearings.

8. The additive manufacturing system as claimed in claim 1, wherein the sensing unit comprises a plurality of sensors selected from: an infrared camera, a laser profilometer, a thermal imaging camera, a photodiode and a pyrometer.

9. A method for additive manufacturing of an object, the method comprising:
supporting the object to be manufactured on a foundation platform;
depositing a material, in a layer-by-layer manner, onto the foundation platform to manufacture the object, wherein the material application unit comprises:
a deposition head to deposit the material; and
a feeder to feed the material to the deposition head;
selectively melting the deposited material using a thermal unit;
facilitating movement of at least one of: the foundation platform, the material application unit and the thermal unit using a dynamic positioning unit;
determining current operating parameters of each of the material application unit, the thermal unit and the dynamic positioning unit and a current temperature profile of the melted material using a sensing unit;
determining and optimizing manufacturing parameters for the object based on the current operating parameters and the current temperature profile using a control unit, wherein the manufacturing parameters comprise:
quantity of the material deposited;
heating settings;
cooling speed;
speed of the dynamic positioning unit; and
direction of the dynamic positioning unit.

10. The method as claimed in claim 9, wherein the material application unit comprises a material reservoir connected to the feeder and wherein the method comprises transporting the material from the material reservoir to the deposition head in a controlled manner.

11. The method as claimed in claim 9, wherein the thermal unit comprises a laser source and a set of focusing lenses, wherein the method comprises emitting a laser beam by the laser source and directing and focusing the emitted laser beam by the set of focusing lenses onto the deposited material to selectively melt and fuse the material.

12. A computer program product comprising a non-transitory computer-readable storage medium storing instructions which, when executed by a processor, cause an additive manufacturing system to perform a method for additive manufacturing of an object, the method comprising:
supporting the object to be manufactured on a foundation platform;
depositing a material, in a layer-by-layer manner, onto the foundation platform to manufacture the object, wherein the material application unit comprises:
a deposition head to deposit the material; and
a feeder to feed the material to the deposition head;
selectively melting the deposited material using a thermal unit;
facilitating movement of at least one of: the foundation platform, the material application unit, and the thermal unit using a dynamic positioning unit;
determining current operating parameters of each of the material application unit, the thermal unit, and the dynamic positioning unit using a sensing unit;
determining a current temperature profile of the melted material using the sensing unit;
determining and optimizing manufacturing parameters for the object based on the current operating parameters and the current temperature profile using a control unit, wherein the manufacturing parameters comprise:
quantity of the material deposited;
heating settings;
cooling speed;
speed of the dynamic positioning unit; and
direction of the dynamic positioning unit.
